(19) United States
(12) Patent Application Publication
(10) Pub. No.: US 2002/0067805 A1
(43) Pub. Date: Jun. 6, 2002

(54) METHOD OF AND APPARATUS FOR INTERACTIVE AUTOMATED PRODUCTION AND RECORDING OF AN AUDIO FILE AND PROVIDING AUTOMATED ADDRESSABLE ACCESS TO AND TRANSMISSION AND PLAYBACK OF RECORDED AUDIO FILES

(76) Inventor: CHRISTOPHER C. ANDREWS, LOS ALTOS, CA (US)

Correspondence Address: HAVERSTOCK & OWENS LLP, 162 NORTH WOLFE ROAD, SUNNYVALE, CA, 94086, US

(21) Appl. No.: 09/374,408

(22) Filed: Aug. 13, 1999

(51) Int. Cl. H04M 1/64

(52) U.S. Cl. 379/67.1; 379/88.17

(57) ABSTRACT

An apparatus for recording an audio file allows a user to establish a telephony connection with a call processing and recording system. Once the telephony connection is established and it is determined that the user is a registered user, the user records an audio file. The user then has the ability to playback, edit and re-record the audio file until satisfactory. Once satisfactory the recorded audio file and an associated title are stored at the call processing and recording system. The recorded audio file is then reviewed to ensure that the quality and content of the recorded audio file is acceptable. If acceptable, the recorded audio file, the associated title and user information are then transmitted from the call processing and recording system to an associated internet server. When the internet server receives the recorded audio file and accompanying data, this information is then stored in a recording database. The recorded audio file is associated with a profile of the recording user allowing the user or the public to access the recorded audio file and corresponding information over the internet. An e-mail or other form of notification is also sent to the user notifying them of the address at which the recorded audio file can be accessed. Access to the recorded audio file can then be achieved by accessing this address over the internet. A user can later update, edit and re-record a previously recorded audio file. If directed by the user to a specific location, a link to the recorded audio file is also automatically posted at the specific location. Preferably, when the corresponding address is accessed, the audio data within the recorded audio file is transmitted from the internet server to the accessing computer system for playback at that accessing computer system. Alternatively, the recorded audio file is combined at an internet server with a message or other file from the user to be delivered to one or more specified locations.

### FIELD OF THE INVENTION

The present invention relates to the field of recording audio information. More particularly, the present invention relates to the field of recording and storing audio information at an addressable location.

### BACKGROUND OF THE INVENTION

The World Wide Web (also known as and hereinafter referred to as the “Internet”) is a rapidly expanding network of computers which provide users with numerous services and a wealth of information. The internet is primarily a visually based system, allowing a user to graphically interact with an image or series of images on a display screen.

The internet was originally created as a non-commercial venue to provide communication links between government institutions as well as institutions of higher learning. Today, the internet has evolved to become a universal network of computers which include private industry as well as government institutions. The internet has become widely accessible to many people from computers located in many different places including homes and offices. Users are able to locate updated information regarding the weather, stock prices, news and many other topics. Further, users are able to locate a wide variety of information regarding products and services. Users are also able to communicate with other users over the internet through e-mail, bulletin boards, message lists and chat sites.

The internet offers many advantages over other media. The internet seamlessly links together and provides to users information stored on geographically distant servers. Similarly, the information on a server can be remotely updated from any geographic point from which access to the internet can be obtained.

When a user accesses information on a server over the internet, the user interfaces with the server through a website. Many websites offer hyperlinks to other websites, making the internet user friendly and allowing users to efficiently jump between websites and webpages. When accessing a website with a hyperlink to another website, by selecting the hyperlink, the user is enabled to link directly from the current website to the linked website without entering an address of the linked website. In use, a hyperlink is a visually discernible notation. The user activates or selects the hyperlink by “clicking” on the hyperlink notation or icon. This selection of the hyperlink is also referred to as a point and click operation. The user's computer is programmed to automatically access the website identified by the hyperlink as a result of the user's point and click operation.

When accessing an internet site, a user instructs a computer system, settop box or other internet access device to dial up the server of the user's internet service provider. The internet access device then controls the operation of a modem to establish the connection with the internet service provider over the public switched telephone network. Once a connection has been made between the modem and the internet service provider, the user must then log on to the service, usually by entering a username and a password. When the user is logged on to the service, the user can then access services and information provided by the service provider and also information available through web pages at other addresses on the internet. When accessing information available over the internet, the user connects through their service provider to other servers which are providing information. This information is usually provided at internet sites and web pages. Each internet site and web page has a particular address through which it can be accessed. By entering this address, the user is instructing their internet service provider to connect them to that address. As described above, the user also instructs their internet service provider to connect them to a specific address by selecting a hyperlink through a point and click operation.

Audio information is currently accessible over the internet in several different formats. There are live and recorded radio broadcasts from stations all over the world available for listening and accessible to users over the internet. On other sites audio information is available as an accompaniment to news and information stories. This information is generally recorded by the information provider and added to the web site displaying the information. Voice chat capability is also being added to internet chat sites, allowing users to chat online in both text and audio formats. This information is not recorded. There is currently no recording system which allows general users of the internet to automatically record audio information from a remote location and post it at an addressably accessible site on the Internet.

### SUMMARY OF THE INVENTION

An apparatus for recording an audio file allows a user to establish a telephony connection with a call processing and recording system. Once the telephony connection is established and it is determined that the user is a registered user, the user records an audio file. The user then has the ability to playback, edit and re-record the audio file until satisfactory. Once satisfactory the recorded audio file and an associated title are stored at the call processing and recording system. The recorded audio file is then reviewed to ensure that the quality and content of the recorded audio file is acceptable. If acceptable, the recorded audio file, the associated title and user information are then transmitted from the call processing and recording system to an associated internet server. When the internet server receives the recorded audio file and accompanying data, this information is then stored in a recording database. The recorded audio file is associated with a profile of the recording user allowing the user or the public to access the recorded audio file and corresponding information over the internet. An e-mail or other form of notification is also sent to the user notifying them of the address at which the recorded audio file can be accessed. Access to the recorded audio file can then be achieved by accessing this address over the internet. A user can later update, edit and re-record a previously recorded audio file. If directed by the user to a specific location, a link to the recorded audio file is also automatically posted at the specific location. Preferably, when the corresponding address is accessed, the audio data within the recorded audio file is transmitted from the internet server to the accessing computer system for playback at that accessing computer system. Alternatively, the recorded audio file is combined at an internet server with a message or other file from the user to be delivered to one or more specified locations.

In one aspect of the present invention, a method of recording an audio file for playback over a computer system includes the steps of establishing a telephony connection between a telephony device and a call recording device, recording an audio communication transmitted over the telephony connection thereby establishing a recorded audio file and associating an address with the recorded audio file, such that when the address is accessed using the computer system, the recorded audio file is transmitted to the computer system for playback. The step of associating is performed by a server on which the recorded audio file is stored at the address. The method further comprises the step of playing back the recorded audio file when the address is accessed. The address is accessed by transmitting an html address over an internet connection. The method further comprises the step of establishing the internet connection. The html address is transmitted over the internet connection by selecting a hyperlink pointing to the address. The server is at a remote location from the computer system. The method further comprises the step of determining if a user establishing the telephony connection has a user profile within a user database. The recorded audio file is first available for playback at a time after the step of recording is begun. The time is specified by a user and includes a range from immediately available for playback to available for playback after a delay period. The time is also determined by a location profile corresponding to a site at which the recorded audio file is stored and includes a range from immediately available for playback to available for playback after a delay period. A notification is sent to a user responsible for establishing the telephony connection specifying the address associated with the recorded audio file. The method further includes the step of automatically posting a link pointing to the address. The link is preferably posted at a predetermined location. The method further includes the step of associating descriptive information with the recorded audio file. Preferably, the descriptive information includes a title.

In another aspect of the present invention, a method of recording an audio file for playback over a computer system includes the steps of establishing a telephony connection between a telephony device and a call recording device, recording an audio communication transmitted over the telephony connection thereby establishing a recorded audio file and associating the recorded audio file with a second file, such that when the second file is accessed using the computer system, the recorded audio file is available for playback at the computer system. The step of associating is performed by a server on which the recorded audio file is stored. The server is preferably at a remote location from the computer system. The method further includes the step of determining if a user establishing the telephony connection has a user profile within a user database. In this aspect, the second file is preferably an e-mail message.

In still another aspect of the present invention, a record and playback system for recording an audio file for later playback includes means for establishing a telephony connection with a telephony device, means for recording coupled to the means for establishing a telephony connection for recording an audio communication transmitted over the telephony connection thereby establishing a recorded audio file and means for storing coupled to the means for recording for storing the recorded audio file at an address, such that when the address is accessed by a computer system, the recorded audio file is transmitted to the computer system for playback. The record and playback system further includes a server including the means for storing. The server is at a remote location from the computer system. A data connection is established between the server and the computer system for transmitting the address and the recorded audio file for playback. The data connection is established by an internet connection. The server is preferably an internet server. The address is accessed by transmitting an html address from the computer system over an internet connection. The html address is transmitted over the internet connection by selecting a hyperlink pointing to the address.

In yet another aspect of the present invention, a record and playback system for recording an audio file for later playback includes an interface circuit configured to establish a telephony connection with a telephony device, a call recording system coupled to the interface circuit to record an audio communication transmitted over the telephony connection thereby establishing a recorded audio file and a storage system coupled to the call recording system to store the recorded audio file at an address within the storage system, such that when the address is accessed by a computer system, the recorded audio file is transmitted to the computer system for playback. The storage system includes a server having a mass storage device on which the recorded audio file is stored at the address. The server is at a remote location from the computer system. A data connection is established between the server and the computer system to transmit the recorded audio file for playback. The data connection is preferably an internet connection. The address is accessed by transmitting an html address from the computer system to the storage system over an internet connection. The html address is transmitted over the internet connection by selecting a hyperlink pointing to the address.

In still yet another aspect of the present invention, a network of devices for recording and playback of an audio file includes a call processing and recording system coupled to a telephone network to establish a telephony connection with a telephony device and record an audio communication transmitted over the telephony connection thereby establishing a recorded audio file, a server coupled to the call processing and recording system to store the recorded audio file at an address and one or more computer systems coupled to the server such that when the address is accessed by one of the computer systems, the recorded audio file is transmitted to an accessing computer system for playback. The server includes a mass storage device on which the recorded audio file is stored at the address. The server is at a remote location from the one or more computer systems. The telephone network is preferably a public switched telephone network. The one or more computer systems are coupled to the server over internet connections. The address is accessed by transmitting an html address from the accessing computer system to the server over the internet connection. The html address is transmitted over the internet connection by selecting a hyperlink pointing to the address.

### BRIEF DESCRIPTION OF THE DRAWINGS

FIG. 1 illustrates a block diagram of an audio recording and access system according to the preferred embodiment of the present invention.

FIG. 2 illustrates a block diagram of the call processing and recording system 12 of the present invention.

FIG. 3 illustrates a block diagram of the internet server 14 of the present invention.

FIG. 4 illustrates a block diagram of the computer system 20 according to the preferred embodiment of the present invention.

FIG. 5 illustrates a flowchart of the process by which a user records an audio file at the call processing and recording system 12 for later access on the internet server 14.

FIG. 6 illustrates a flowchart of the process by which a user accesses a stored recorded audio file.

### DETAILED DESCRIPTION OF THE PREFERRED EMBODIMENT

An apparatus for recording an audio file allows a user to establish a telephone connection with a call processing and recording system. Once the telephone connection is established and it is determined that the user is a registered user, the user records an audio file. The user can record any type of audio that can be received and transmitted by their telephone device, including but not limited to speech, singing, music and other audible noises. Once recorded, the user then has the ability to playback, edit and re-record the audio file until the user is satisfied with the audio file. Once the user is satisfied with the recorded audio file, a title or text description to be associated with the recorded audio file and the recorded audio file are stored at the call processing and recording system. The text description is information to be associated with the recorded audio file including location at which the recorded audio file is to be displayed or posted, association with photos or other content, volume at which the recorded audio file is played back and sequence date if the recorded audio file is part of a sequence of audio files. The recorded audio file is then reviewed to ensure that the quality and content of the recorded audio file is acceptable. When the quality and content of the recorded audio file is acceptable, then the recorded audio file, the associated title and user information is transmitted from the call processing and recording system to an internet server.

When the internet server receives the recorded audio file, user information and the associated title or text description, this data is then stored in a recording database at the internet server. The recorded audio file is also associated with a profile of the recording user which is accessible by the user over the internet. An e-mail notification is also preferably sent to the recording user notifying the recording user of the address at which the recorded audio file can be accessed. Alternatively, any other appropriate form of notification is sent or provided to the recording user notifying them of the address at which the recorded audio file can be accessed. The user can then provide this address to others allowing them to access the recorded audio file on the internet server by entering this address or selecting a hyperlink pointing to this address. If directed by the user to a specific location, a link to the recorded audio file is also automatically posted at the specific location. Preferably, the recorded audio file is accessed by entering the address of the recorded audio file or selecting a hyperlink pointing to this address. When accessed from the internet server, the audio data within the recorded audio file is transmitted to the accessing computer system for playback at that accessing computer system. In an alternate embodiment, the recorded audio file is combined at an internet server with a message or other file from the user to be delivered to one or more specified locations. In either the preferred embodiment or this alternate embodiment, the controller controls the automated production and recording of an audio file and the relationship between the user information and the location information associated with a recorded audio file.

Multiple recorded audio files can also be automatically sequentially accessed by an accessing computer system. A recording user can also later update, edit or re-record a previously recorded audio file to change the recorded audio file at a specific address.

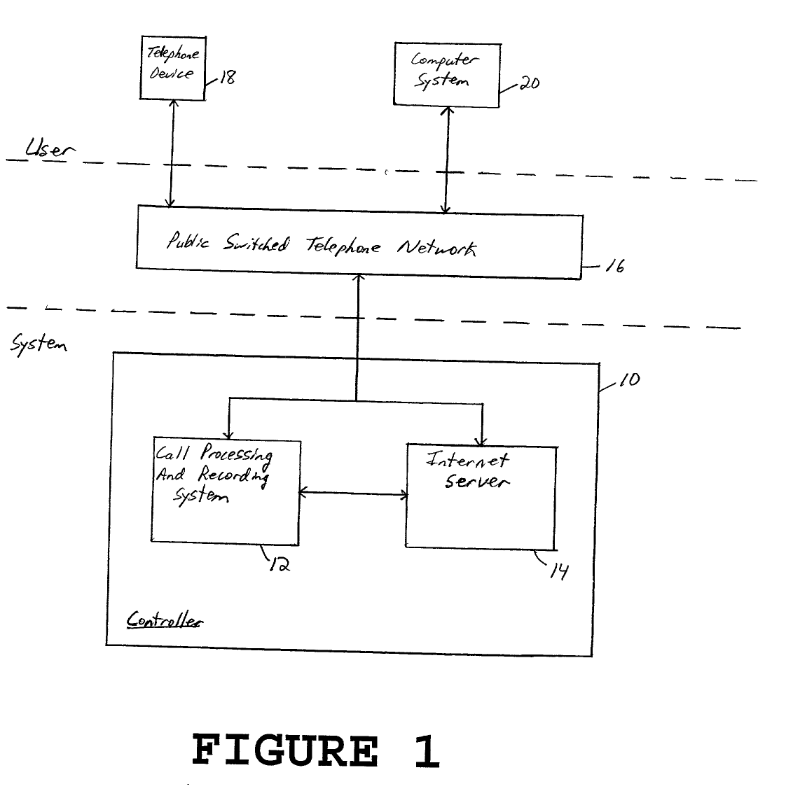

A block diagram of an audio recording and access system according to the preferred embodiment of the present invention is illustrated in FIG. 1. A controller 10 includes a call processing and recording system 12 and an internet server 14, coupled to each other. The controller 10 is coupled to the public switched telephone network 16 to allow communications between both the internet server 14 and the call processing and recording system 12 and remote devices over the public switched telephone network 16. In the exemplary configuration illustrated in FIG. 1, a telephone device 18 and computer system 20 are also both coupled to the public switched telephone network 16 to allow a user access to both the call processing and recording system 12 and the internet server 14 from these remote devices.

Using the telephone device 18, a user can establish a connection with the call processing and recording system 12 to record an audio file. Using the computer system 20, a user can establish a connection over the internet with the internet server 14 to access a recorded audio file or update a user profile. While the telephone device 18 and the computer system 20 are shown as separate devices, it should be apparent to those skilled in the art that alternatively, the telephone device 18 and the computer system 20 could be a single integrated device having ability to both transmit and receive audio information and to provide access to the internet over the public switched telephone network 16.

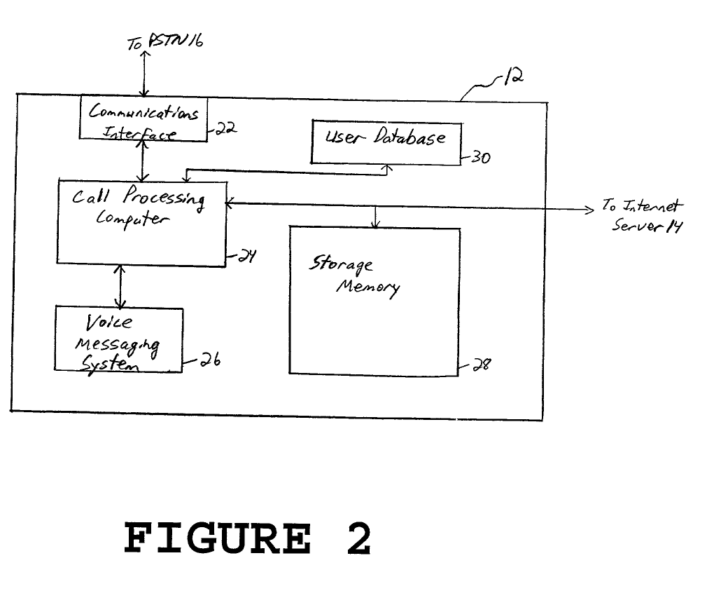

A block diagram of the call processing and recording system 12 is illustrated in FIG. 2. The call processing and recording system 12 includes a communications interface 22, a call processing computer 24, a voice messaging system 26, a storage memory 28 and a user database 30. The communications interface 22 is preferably coupled to the public switched telephone network 16 to allow the call processing and recording system 12 to communicate with remote devices, such as the telephone device 18, over the public switched telephone network 16. The call processing computer 24 is coupled to the communications interface 22 to control the communications with remote devices. The call processing computer 24 is coupled to a voice messaging system 26 to provide voice messages, commands and prompts to users accessing the call processing and recording system 12. The call processing computer 24 is coupled to the user database 30 to obtain and store information and profiles of users of the system. The call processing computer 24 is also coupled to a storage memory 28 and to the internet server 14 to store audio messages recorded by users and to provide those recorded audio messages to the internet server 14.

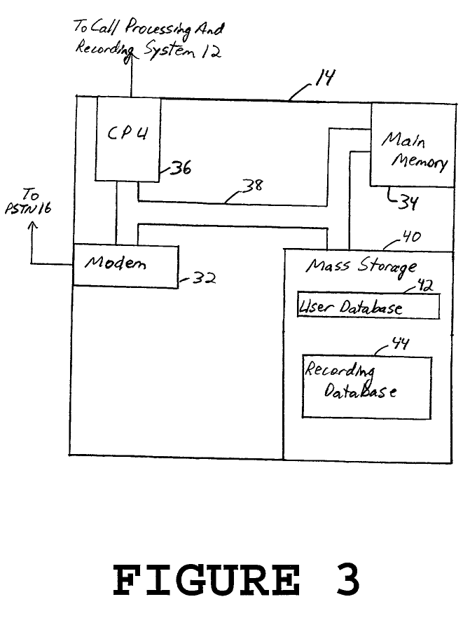

A block diagram of the internal components of the internet server 14 is illustrated in FIG. 3. The internet server 14 includes a central processing unit (CPU) 36, a main memory 34, a mass storage device 40 and a modem 32, all coupled together by a conventional bidirectional system bus 38. The modem 32 is preferably coupled to the public switched telephone network 16 for sending and receiving communications. The mass storage device 40 is utilized to store a user database 42 and a recording database 44. The mass storage device 40 may include both fixed and removable media using any one or more of magnetic, optical or magneto-optical storage technology or any other available mass storage technology. The system bus 38 contains an address bus for addressing any portion of the memory 34 and 40. The system bus 38 also includes a data bus for transferring data between and among the CPU 36, the main memory 34, the mass storage device 40 and the modem 32.

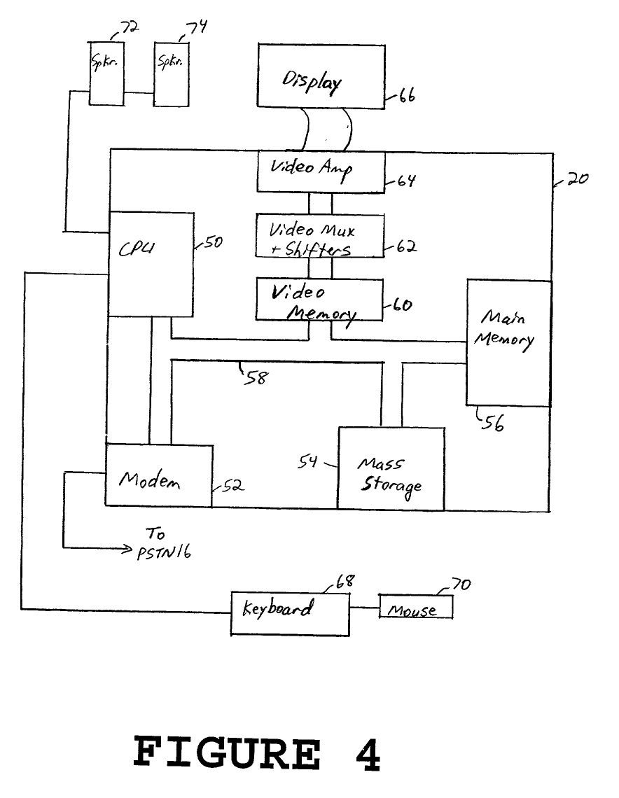

A block diagram of the internal components of the computer system 20 is illustrated in FIG. 4. While the method of accessing recorded audio files of the present invention can be performed on any appropriately configured computer system or internet access device, an exemplary computer system 20 is illustrated in FIG. 4. The computer system 20 includes a CPU 50, a main memory 56, a video memory 60, a mass storage device 54 and a modem 52 all coupled together by a conventional bidirectional system bus 58. The modem 52 is preferably coupled to the public switched telephone network 16 for sending and receiving communications. The mass storage device 54 may include both fixed and removable media using any one or more of magnetic, optical or magneto-optical storage technology or any other available mass storage technology. The system bus 58 contains an address bus for addressing any portion of the memory 54, 56 and 60. The system bus also includes a data bus for transferring data between and among the CPU 50, the main memory 56, the video memory 60, the mass storage device 54 and the modem 52.

The computer system 20 is also coupled to a number of peripheral input and output devices including the keyboard 68, the mouse 70, the associated display 66 and the audio playback speakers 72 and 74. The keyboard is coupled to the CPU 50 for allowing a user to input data and control commands into the computer system 20. A conventional mouse 70 is coupled to the keyboard 68 or computer system 20, directly, for manipulating graphic images on the display 66 as a cursor control device in a conventional manner. The display 66 displays video and graphical images generated by the computer system 20. The audio playback speakers 72 and 74 allow playback of audio information from the computer system 20.

A port of the video memory 60 is coupled to a video multiplex and shifter circuit 62, which in turn is coupled to a video amplifier 64. The video amplifier 64 drives the display 66, when it is being used. The video multiplex and shifter circuitry 62 and the video amplifier 64 convert pixel data stored in the video memory 60 to raster signals suitable for use by the display 66.

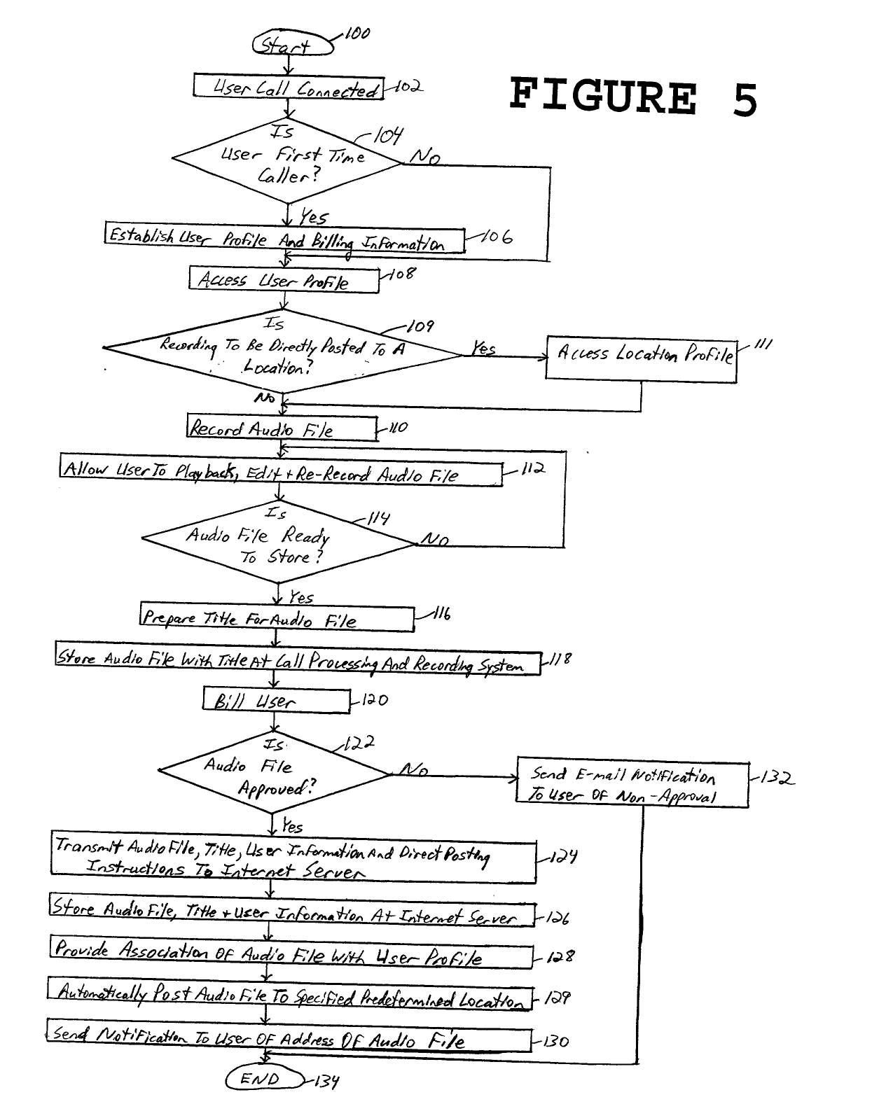

A flowchart illustrating the process by which a user records an audio file at the call processing and recording system 12 for later access on the internet server 14 is illustrated in FIG. 5. The process begins at the step 100. At the step 102, a user's call is connected to the call processing and recording system 12 to establish a connection between the user's telephone device 18 and the call processing and recording system 12. It is then determined, at the step 104, if the user is a first time caller. If the user is a first time caller, a user profile, including contact and billing information, is established at the step 106. After a user profile is established or if it is determined that the user is not a first time caller and has a user profile within the user database 30, then the user profile is accessed at the step 108. At the step 109, it is determined if the audio file the user is about to record is to be posted directly to a location, such as a specific website or webpage. If it is determined that the recorded audio file is to be directly posted to a specific location, then the location profile for the specified location is accessed at the step 111.

If the recorded audio file is not to be directly posted to a specific location or after the location profile is accessed at the step 111, the user is then instructed and allowed to record the audio file, at the step 110, over the connection between the telephone device 18 and the call processing and recording system 12. The location profile is utilized to tailor the recording of the audio file to requirements of the specified location to which the recorded audio file is to be directly posted, if any. The location profile preferably includes path, access, administrative, technical, content and timing of playback information. The location profile further includes any information required in order to automatically directly post the audio file within the appropriate specified location. The timing of playback information preferably specifies a duration that the recorded audio file is available for playback and a time of playback in a range from immediate to a delay of a specified amount of time. After the audio file is recorded, the user is then allowed to playback, edit and re-record the audio file, at the step 112, until the user is satisfied with the recorded audio file. The user is then finally asked if the recorded audio file is ready to store, at the step 114. If the recorded audio file is not ready to store, the process jumps back to the step 112 to allow the user to playback, edit and re-record the audio file. Once the recorded audio file is satisfactory to the user and ready to store, a title and accompanying text description is prepared at the step 116, and associated with the recorded audio file.

The recorded audio file and title are then stored at the call processing and recording system 12 at the step 118. The user is then also billed for the recorded audio file at the step 120. It is then determined, at the step 122, if the quality and content of the recorded audio file is acceptable. If either the quality or content of the recorded audio file is not acceptable, the recorded audio file is not stored and the user is sent an e-mail or other form of notification, at the step 132, that the recorded audio file was found not acceptable. If the recorded audio file was found not acceptable, the process then ends at the step 134.

If both the quality and content of the recorded audio file was found acceptable at the step 122, then the audio file, title, text description, corresponding user information and direct posting instructions are transmitted to the internet server 14 at the step 124. At the step 126, the audio file, title, text description and corresponding user information is stored by the internet server 14 in the recording database 44 of the mass storage device 40. An association is then made by the internet server 14 between the recorded audio file and the user's profile at the step 128. If appropriate, at the step 129, the recorded audio file is directly posted at the location specified by the user for direct posting. At the step 130, an e-mail or other form of notification is sent to the user notifying the user of the address of the recorded audio file. The recording and storage process then ends at the step 134.

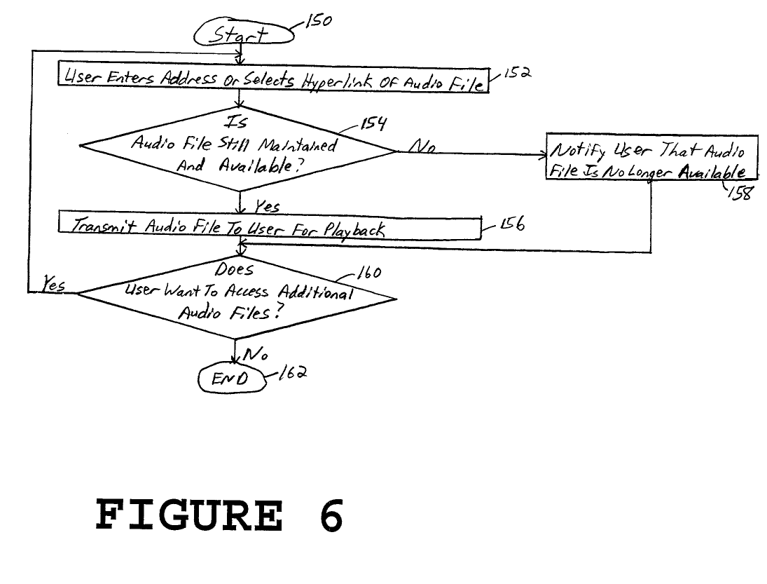

A flowchart illustrating the process by which a user accesses a stored recorded audio file is illustrated in FIG. 6. The accessing process begins at the step 150. At the step 152, a user accessing the internet server 14, enters an address or selects a hyperlink of a recorded audio file to be accessed. The internet server 14 then determines, at the step 154, if the recorded audio file for which the address was entered is still maintained and available. If it is determined that the recorded audio file for which the address was entered is not still maintained and available, the user is notified of such at the step 158. If it is determined that the recorded audio file for which the address was entered is still maintained and available, then, at the step 156, the audio information corresponding to the recorded audio file is transmitted from the internet server 14 over the internet to the user's computer system 20 to allow the user to hear the accessed audio file. After both the steps 156 and 158, it is then determined at the step 160 if the user desires to access additional audio files. If the user does want to access additional audio files then the process jumps back to the step 152 where the user enters an address or selects a hyperlink of an additional recorded audio file. Otherwise, if the user does not want to access additional audio files, then the process ends at the step 162. A recording user can also access a previously recorded audio file in order to edit or rerecord the audio file to replace the recorded audio file at an address location. When playing back recorded audio files, a user can also instruct their computer system 20 to sequentially playback multiple recorded audio files within a list of selected recorded audio files.

The call processing and recording system 12 receives and processes calls from users to record audio files. To record an audio file, a user preferably calls into the call processing and recording system 12 through the public switched telephone network 16 using a telephone device 18 to establish a connection between the telephone device 18 and the call processing and recording system 12. Once a call is connected between the user and the call processing and recording system 12, the call processing computer 24, using the voice messaging system 26, prompts the user to determine if the user is a first time user or a previously registered user. If the user is not a previously registered user, the user is prompted to obtain information about the user such as name, home address, e-mail address, telephone number and billing information in order to generate a profile for the user. This information is preferably given by the user to a customer service operator who enters it into the user database. Alternatively, this user profile information can be entered into the user database in any available manner, including using speech recognition technology and by using the keypad of a touch-tone telephone. In a further alternate embodiment, the user profile information is generated and updated by the user from a computer system 20 connected to the internet server 14 over an internet connection. The user is also given an access number to use each time they access the call processing and recording system 12 to record an audio file. The user profile and access number are then stored within the user database 30. Once the user is a registered user, when accessing the call processing and recording system 12, the user just enters their access number and a password or personal identification number (pin) and the corresponding user profile is accessed from the user database 30.

When it is established that the user is a registered user and the user profile is accessed from the user database 30, the user is then prompted to determine if the audio file the user is about to record is to be posted directly to a predetermined location. If the recorded audio file is to be directly posted to a specific location, then the location profile for the specified location is accessed and used to tailor the recording of the audio file to the requirements of the specified location, if any. The user is then prompted to record their audio file. After the audio file is initially recorded, the user is then prompted to determine if the user would like to playback, edit or re-record the audio file. Once the user is satisfied with the audio recording, a title and accompanying text description is prepared for the audio file. Preferably, the title associated with the audio file is the calendar date of recording and the number of times the user has recorded an audio file on this calendar date. Alternatively, the title is any appropriate information used to distinguish the recorded audio file which is either entered automatically by the system or entered by the user. The audio file and its title are then stored in the storage memory 28 at the call processing and recording system 12. The user is then preferably automatically billed, based on the billing information within the user profile, the length of the recorded audio file and the length of time the user was connected to the call processing and recording system 12.

After being stored in the storage memory 28, the audio file is then preferably listened to by a reliability operator to ensure that the audio file playback is of good quality and that the content of the audio file is acceptable. Once approved by the reliability operator, the audio file, title, text description, corresponding user information and direct posting instructions are transmitted to the internet server 14 from the call processing and recording system 12. In an alternate embodiment, portions of the approval and quality review process are automated by converting the speech within the audio file to a text format and then searching for certain keywords that are on a list of unacceptable content. In a further alternate embodiment, the approval and quality review process is not performed before the audio file, title, text description, corresponding user information and direct posting instructions are transmitted from the call processing and recording system 12 to the internet server 14.

When the internet server 14 receives the audio file, title, text description, corresponding user information and direct posting instructions from the call processing and recording system 12, the audio file, title, text description and corresponding user information are stored within the recording database 44 in the mass storage device 40. The corresponding user information is then used to access the user profile in the user database 42. At the internet server 14, a profile of each user corresponding to the user profile stored in the user database 30 is stored in the user database 42. A user accessing the internet server 14 over the internet using a computer system 20 preferably has the ability to change their corresponding user profile while connected to the internet server 14. Using the user information received from the call processing and recording system 12, an association is generated between the recorded audio file and the user profile, allowing the user to access the recorded audio file by entering their user number and a password. When accessing the recorded audio file, the user can choose to extend the time that the recorded audio file is maintained by the internet server 14, delete the recorded audio file or change the information, such as the title and text description, associated with the recorded audio file. Preferably, each recorded audio file is stored in an archive database after a period of time, for later retrieval or replay. Alternatively, each recorded audio file is preferably only saved for a limited time period by the internet server 14 unless extended by the user.

If appropriate, when the recorded audio file is saved in the recording database, the recorded audio file is then directly posted at the location specified by the user for direct posting. The direct posting of an audio file at a specified location is preferably accomplished automatically by providing a link at the specific location by which the recorded audio file can be accessed. In this manner, the recorded audio file can be provided as an entry to a contest at a specific location or provided as audio content on a webpage or site pertaining to a specific subject. A user then accessing content at this specific location is provided with recorded audio files of a particular interest or related to a defined subject matter. When accessing content at such a location, a user can select multiple links at a time to listen sequentially to many recorded audio files.

Also, when the recorded audio file is saved in the recording database 44 by the internet server 14, an e-mail or other form of notification is sent to the user notifying the user that the recorded audio file has been saved at the internet server 14 and at what address the recorded audio file can be accessed. The user can then use this address as a hyperlink on a website or as an attachment to an e-mail or other communication to provide the address of the recorded audio file to others allowing them to access the recorded audio file for playback. Anyone then either entering the appropriate address or selecting an appropriate hyperlink pointing to this address will hear the playback of the corresponding recorded audio file through the audio playback speakers 72 and 74 at the computer system 20 they are using to access the internet server 14.

When the address of the recorded audio file is accessed at the internet server 14 by entering the address or selecting a hyperlink pointing to the address of the recorded audio file, the internet server 14 transmits the audio data stored within the recorded audio file to the computer system 20 accessing the recorded audio file. The computer system 20 receiving the audio data of the recorded audio file will then cause the appropriate audio, representing the original recorded message, to be played back for the listener on the audio speakers 72 and 74 of the computer system 20. Anyone accessing the internet and entering this address or selecting the appropriate hyperlink pointing to this address will then be provided the corresponding audio from the accessed recorded audio file.

In the manner described herein, a user is able to record an audio file over a connection established between a telephone device 18 and the call processing and recording system 12 of the controller 10. Once recorded, an audio file is accessible over the internet by entering the corresponding address or selecting an appropriate hyperlink pointing to the address of the recorded audio file. When accessed over the internet at the internet server 14, the audio data within the recorded audio file is transmitted from the internet server 14 to the accessing computer system 20 over the internet for playback at the accessing computer system 20.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is accessible over the internet through the public switched telephone network, the present invention could also be accessible on any other appropriate communication structures, including intranets, direct connections and the like.

I claim:

1. A method of recording an audio file for playback over a computer system comprising the steps of:
a. establishing a telephony connection between a telephony device and a call recording device;
b. recording an audio communication transmitted over the telephony connection thereby establishing a recorded audio file; and
c. associating an address with the recorded audio file, such that when the address is accessed using the computer system, the recorded audio file is transmitted to the computer system for playback.

2. The method as claimed in claim 1 wherein the step of associating is performed by a server on which the recorded audio file is stored at the address.

3. The method as claimed in claim 2 further comprising the step of playing back the recorded audio file when the address is accessed.

4. The method as claimed in claim 3 wherein the address is accessed by transmitting an html address over an internet connection.

5. The method as claimed in claim 4 further comprising the step of establishing the internet connection.

6. The method as claimed in claim 5 wherein the html address is transmitted over the internet connection by selecting a hyperlink pointing to the address.

7. The method as claimed in claim 2 wherein the server is at a remote location from the computer system.

8. The method as claimed in claim 1 further comprising the step of determining if a user establishing the telephony connection has a user profile within a user database.

9. The method as claimed in claim 3 wherein the recorded audio file is first available for playback at a time after the step of recording is begun.

10. The method as claimed in claim 9 wherein the time is specified by a user and includes a range from immediately available for playback to available for playback after a delay period.

11. The method as claimed in claim 9 wherein the time is determined by a location profile corresponding to a site at which the recorded audio file is stored and includes a range from immediately available for playback to available for playback after a delay period.

12. The method as claimed in claim 1 wherein a notification is sent to a user responsible for establishing the telephony connection specifying the address associated with the recorded audio file.

13. The method as claimed in claim 1 further comprising the step of automatically posting a link pointing to the address.

14. The method as claimed in claim 13 wherein the link is posted at a predetermined location.

15. The method as claimed in claim 1 further comprising the step of associating descriptive information with the recorded audio file.

16. The method as claimed in claim 15 wherein the descriptive information includes a title.

17. A method of recording an audio file for playback over a computer system comprising the steps of:
a. establishing a telephony connection between a telephony device and a call recording device;
b. recording an audio communication transmitted over the telephony connection thereby establishing a recorded audio file; and
c. associating the recorded audio file with a second file, such that when the second file is accessed using the computer system, the recorded audio file is available for playback at the computer system.

18. The method as claimed in claim 17 wherein the step of associating is performed by a server on which the recorded audio file is stored.

19. The method as claimed in claim 18 wherein the server is at a remote location from the computer system.

20. The method as claimed in claim 17 further comprising the step of determining if a user establishing the telephony connection has a user profile within a user database.

21. The method as claimed in claim 17 wherein the second file is an e-mail message.

22. A record and playback system for recording an audio file for later playback comprising:
a. means for establishing a telephony connection with a telephony device;
b. means for recording coupled to the means for establishing a telephony connection for recording an audio communication transmitted over the telephony connection thereby establishing a recorded audio file; and
c. means for storing coupled to the means for recording for storing the recorded audio file at an address, such that when the address is accessed by a computer system, the recorded audio file is transmitted to the computer system for playback.

23. The record and playback system as claimed in claim 22 further comprising a server including the means for storing.

24. The record and playback system as claimed in claim 23 wherein the server is at a remote location from the computer system.

25. The record and playback system as claimed in claim 24 wherein a data connection is established between the server and the computer system for transmitting the address and the recorded audio file for playback.

26. The record and playback system as claimed in claim 25 wherein the data connection is established by an internet connection.

27. The record and playback system as claimed in claim 26 wherein the server is an internet server.

28. The record and playback system as claimed in claim 22 wherein the address is accessed by transmitting an html address from the computer system over an internet connection.

29. The record and playback system as claimed in claim 28 wherein the html address is transmitted over the internet connection by selecting a hyperlink pointing to the address.

30. A record and playback system for recording an audio file for later playback comprising:
a. an interface circuit configured to establish a telephony connection with a telephony device;
b. a call recording system coupled to the interface circuit to record an audio communication transmitted over the telephony connection thereby establishing a recorded audio file; and
c. a storage system coupled to the call recording system to store the recorded audio file at an address within the storage system, such that when the address is accessed by a computer system, the recorded audio file is transmitted to the computer system for playback.

31. The record and playback system as claimed in claim 30 wherein the storage system includes a server having a mass storage device on which the recorded audio file is stored at the address.

32. The record and playback system as claimed in claim 31 wherein the server is at a remote location from the computer system.

33. The record and playback system as claimed in claim 32 wherein a data connection is established between the server and the computer system to transmit the recorded audio file for playback.

34. The record and playback system as claimed in claim 33 wherein the data connection is an internet connection.

35. The record and playback system as claimed in claim 30 wherein the address is accessed by transmitting an html address from the computer system to the storage system over an internet connection.

36. The record and playback system as claimed in claim 35 wherein the html address is transmitted over the internet connection by selecting a hyperlink pointing to the address.

37. A network of devices for recording and playback of an audio file comprising:
a. a call processing and recording system coupled to a telephone network to establish a telephony connection with a telephony device and record an audio communication transmitted over the telephony connection thereby establishing a recorded audio file;
b. a server coupled to the call processing and recording system to store the recorded audio file at an address; and
c. one or more computer systems coupled to the server such that when the address is accessed by one of the computer systems, the recorded audio file is transmitted to an accessing computer system for playback.

38. The network of devices as claimed in claim 37 wherein the server includes a mass storage device on which the recorded audio file is stored at the address.

39. The network of devices as claimed in claim 37 wherein the server is at a remote location from the one or more computer systems.

40. The network of devices as claimed in claim 37 wherein the telephone network is a public switched telephone network.

41. The network of devices as claimed in claim 37 wherein the one or more computer systems are coupled to the server over internet connections.

42. The network of devices as claimed in claim 41 wherein the address is accessed by transmitting an html address from the accessing computer system to the server over the internet connection.

43. The network of devices as claimed in claim 42 wherein the html address is transmitted over the internet connection by selecting a hyperlink pointing to the address.
